(19) United States
(12) Patent Application Publication
(10) Pub. No.: US 2013/0191265 A1
(43) Pub. Date: Jul. 25, 2013

(54) CLOUD-BASED SYSTEM FOR PERFORMING ONLINE TRADING

(71) Applicant: KUNAL NANWANI, CHANDIGARH (IN)

(72) Inventor: KUNAL NANWANI, CHANDIGARH (IN)

(21) Appl. No.: 13/745,701

(22) Filed: Jan. 18, 2013

(30) Foreign Application Priority Data
Jan. 23, 2012 (IN) 276/CHE/2012

(51) Int. Cl. G06Q 40/04

(52) U.S. Cl. CPC G06Q 40/04
USPC 705/37

(57) ABSTRACT

A trading system including an online trading account holder having a paid subscription to access a stock exchange such that a request for performing plurality of transactions over the stock exchange by the account holder is processed by a remote server using the processing capabilities of the computing device associated with the online trading account holder such that in an event that the processing capabilities meet a predetermined criterion, the processing is done using the processing capabilities of the computing device else using the processing capabilities of the remote server.

### FIELD OF THE INVENTION

The present disclosure generally relates to online trading, and in particular relates to a cloud-based system for performing automated online trading.

### BACKGROUND

Portable computing devices such as mobile and laptops have become an integral part of modern life. Most of these platforms are primitive in sense that they are not portable, very proprietary in nature, and lack the portability needed in a world of sharing of financial information, using which financial transactions are performed. Also, these platforms are not fast enough to provide instant value of prices and instead allow users or brokers to place an order which would be confirmed some time later. Their requirement is not just for sharing data or communication or mere storage of information but also for making various online transactions over web portals offering sale and purchase of goods and services. This has lead to various trading stock exchanges of the worlds to provide online portals and thus aid various remote users to perform online trading for financial assets from comfort of their home, office, or on the go.

However, these systems developed so far are not portable in any real sense. There is a limit to the method and systems which can aid a user in smooth online experience. Also, these systems lack automated performance and intelligence to make the devices function by themselves in the absence of an associated user. Also, a portable computing device associated with various users lacks necessary parameters or hardware and software essential to support processing of large chunk of data—this become a burden for the information device and hence the user, especially if immediate processing of data is required.

Thus, there is still a gap in meeting the user requirement and expectation; especially this limitation arises due to limited processing capabilities of the portable computing devices.

### SUMMARY

To overcome the aforesaid challenges, the present disclosure proposes a system of performing online and automated trading using a cloud processing system, which bars no limitation to the processing capabilities of the computing device. The system has a first computing device, portable or stationery controlled by a first user, a second computing device controlled by second user and a cloud computing resource and the exchange where the ultimate trading would happen. The cloud computing resources has instructions including, but not limited to, instructions to authenticate first and second computing device, instructions enable communication between first device and second device, instructions to implement third party applications on first and second device, instructions to store information received and conveyed to first and second computing device in distinct data packages, instructions to provide subscription based access of the cloud computing resource to the first and second user, instructions for automatic functioning of first and second device in absence of first and second user, instructions to utilize computing powers of the first and second device while rendering services to first and second device from a remote resource, instructions to perform the financial transactions on an exchange, instructions to run analytics services along with the rest of the financial trading platform, instructions to have a failover process to the first or second device or to another cloud back device, instructions to push onto the first and second computing device plurality of geographical dependent graphical user interface and instructions enable sale and purchase of financial instruments over internet by first device and second device. Also, the first computing device and the second computing device are configured to connect with a financial trading unit over internet such that the first user and the second user implements on the cloud computing resource instructions to connect with the financial trading unit.

In an embodiment of the invention, an online trading system having plurality of users and associated plurality of computing devices, each of the plurality of user connected with at least one of the plurality of financial exchanges such that each of the request for performing an online transaction from the user to the financial exchange is directed to at least one of the plurality of remote computing servers. For each of request, the remote computing server determines the requesting computing device's processor and hardware details, connectivity power network signal strength and battery life, and performs one or more of: executing the request for performing the financial transaction using the computing device's hardware, and executing the request for performing financial on the remote computing server and pushing the results of the request onto the computing device associated with the requesting user.

In another embodiment of the invention, an online trading application plug and play device is configured to connect and perform financial transactions with a financial exchange over the internet. The device has a first processor configured to request information processing onto the financial exchange and a second processor to interrupt the request and determine the processing capabilities of the computing device into which the plug and play device is plugged in and to send the determined capabilities to a remote server having a subscription based access. The remote server, subject to determined capabilities, is configured to process the request using the processing capabilities of the computing device.

### BRIEF DESCRIPTION OF THE DRAWINGS

The above and other features, aspects and advantages of the subject matter will be better understood with regard to the following description, appended claims, and accompanying drawings where:

FIG. 1 is a schematic block diagram illustrating an embodiment of the online trading system in accordance with an exemplary embodiment of the present invention.

FIG. 2 is a schematic block diagram illustrating an embodiment of the online trading system in accordance with an exemplary embodiment of the present invention.

FIG. 3 is a schematic block diagram illustrating an embodiment of the online trading system in accordance with an exemplary embodiment of the present invention.

FIG. 4 is a schematic block diagram illustrating an embodiment of the online trading network in accordance with an exemplary embodiment of the present invention.

FIG. 5 is a flowchart showing a communication method, in accordance with an exemplary embodiment of the present invention.

### DETAILED DESCRIPTION OF THE DRAWINGS

The preferred embodiment of the present invention and its advantages are best understood by referring to the drawings, in which like numerals have been used for like and correct understanding of the various drawings and hence the invention.

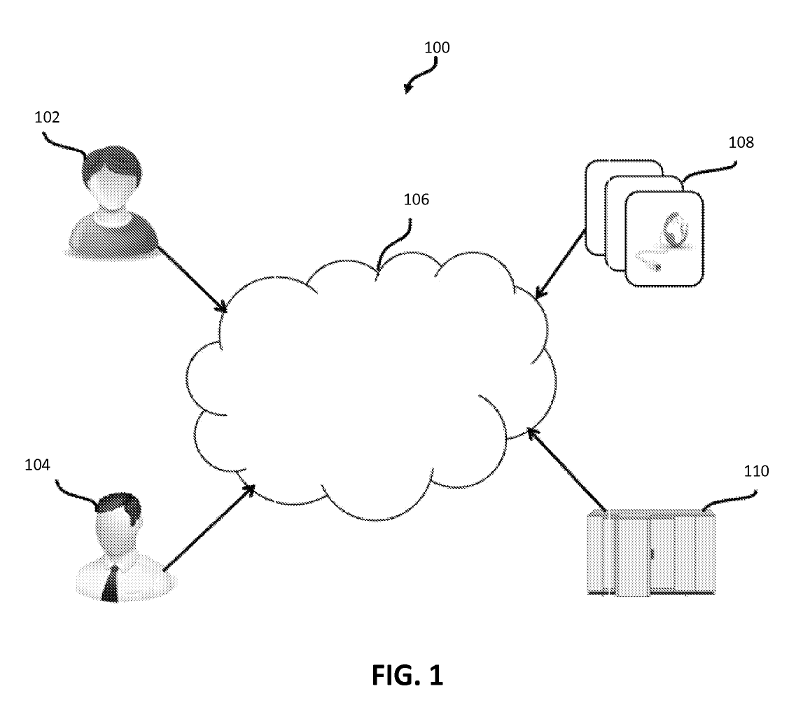

FIG. 1 illustrates the online trading system, as described and claimed in the present invention.

The illustrated online trading system has multiple users 102 and 104, who may be seeking services from their respective network connections. These network connections may include but are not limited to, Ethernet, local area network (LAN), wide area network (WAN), virtual local area network, and proprietary networks. The users have associated computing devices, these devices may include but not limited to desktop, tablet computers, mobile phones, laptops, and servers. The online trading system makes use of a cloud computing server 106 and a financial trading exchange server 110. The cloud computing server 106 is configured to receive and respond to connection request from the users 102 and 104.

Users access the cloud computing server 106 from web browsers and desktop and mobile apps. The cloud computing server 106 comprises of different instructions to carry out different functions. The cloud computing server 106 authenticates verified users of the online trading system who desires to connect to a financial market and to perform financial transactions. The cloud computing server receives access parameters from the users 102 and 104, these access parameters may include, but are not limited to, a user name and an associated password, a randomly generated number—generated each time the user is connected to a computing device, a set of questionnaire—the questionnaire set by the user or relating to the user's last few activities on using the online trading system and a combination thereof.

The cloud computing server 106 is configured to enable communication between the authenticated users and connects them to financial trading exchange 110. The cloud computing server 106 is configured to provide its subscription based access to users 102 and 104. The cloud computing server 106 is also configured to be platform independent and thus using any third party application 108, the cloud computing server 106 can be upgraded to function on various computing platform. To entertain the user's request, the online subscription may, based upon the credits in the user's account, schedule an automatic upgrade task using the application platform. Such a scheduling may be either done automatically or may be subject of user's preferences. If the credit in the user's account is less than a threshold value, the online subscription may alert the user on the same and decline the user's request and mark a reminder for a to a time in future. The reminder schedule may include, but not be limited to a week, month or any other time as scheduled by the user. Further, the third party application module 108 may be a pay and use system. So, a user may have to pay for every use. The cloud computing server 106 is configured to store information received and conveyed from computing device in distinct data packages on a server at remote location. The cloud computing server 106 is also configured to push the final results onto the graphical user interfaces of the computing devices.

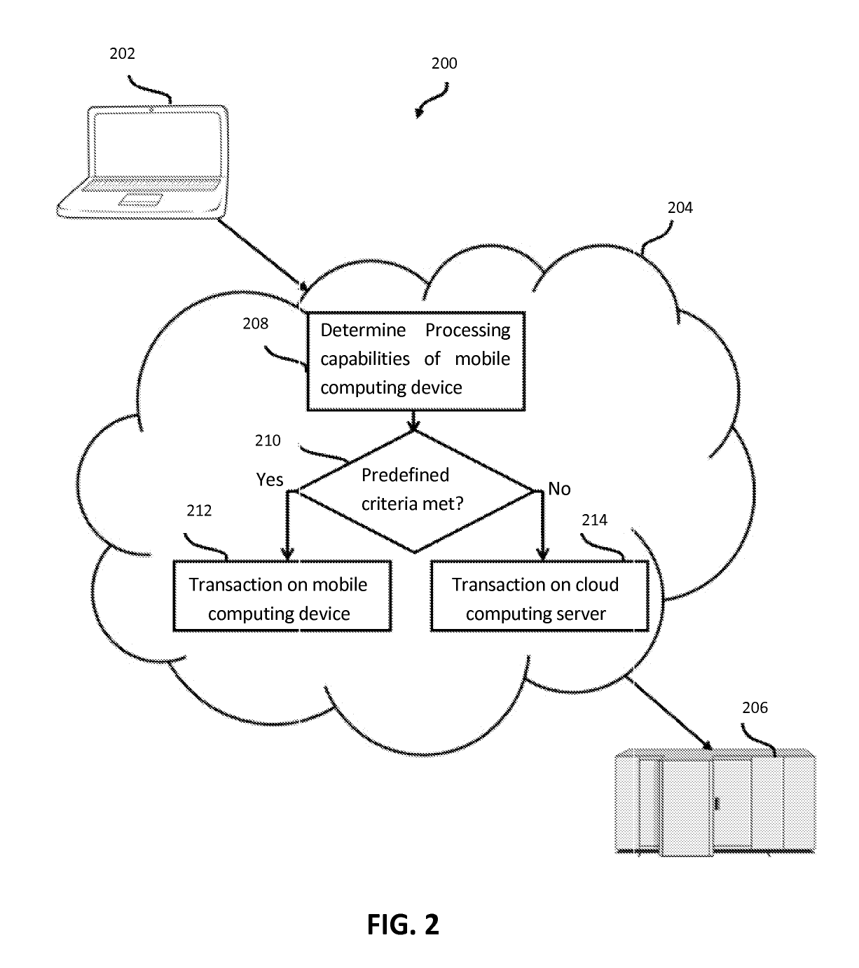

FIG. 2 depicts the components of the online trading system in accordance with an exemplary embodiment of the present invention. The online trading system comprises a mobile computing device 202, a cloud computing server 204, and a financial trading exchange 206. A user of the mobile computing device 202 is an online trading account holder having a paid subscription to access a financial trading exchange 206. A major function of the cloud computing server 204 is to perform a capability check 208 to determine the processing parameters of the mobile computing device 202 associated with the online trading account holder. The capability check 208 is done to analyze mobile computing device's 202 processor and hardware details, connectivity power network signal strength, and battery life. At operation 210, if the predefined criterion is successfully met, then at operation 212 the financial transaction is done using the processing capabilities of the mobile computing device 202. Else if the processing parameters do not meet a predetermined criterion, the financial transaction is done using the processing capabilities of the cloud computing server 204, at operation 214.

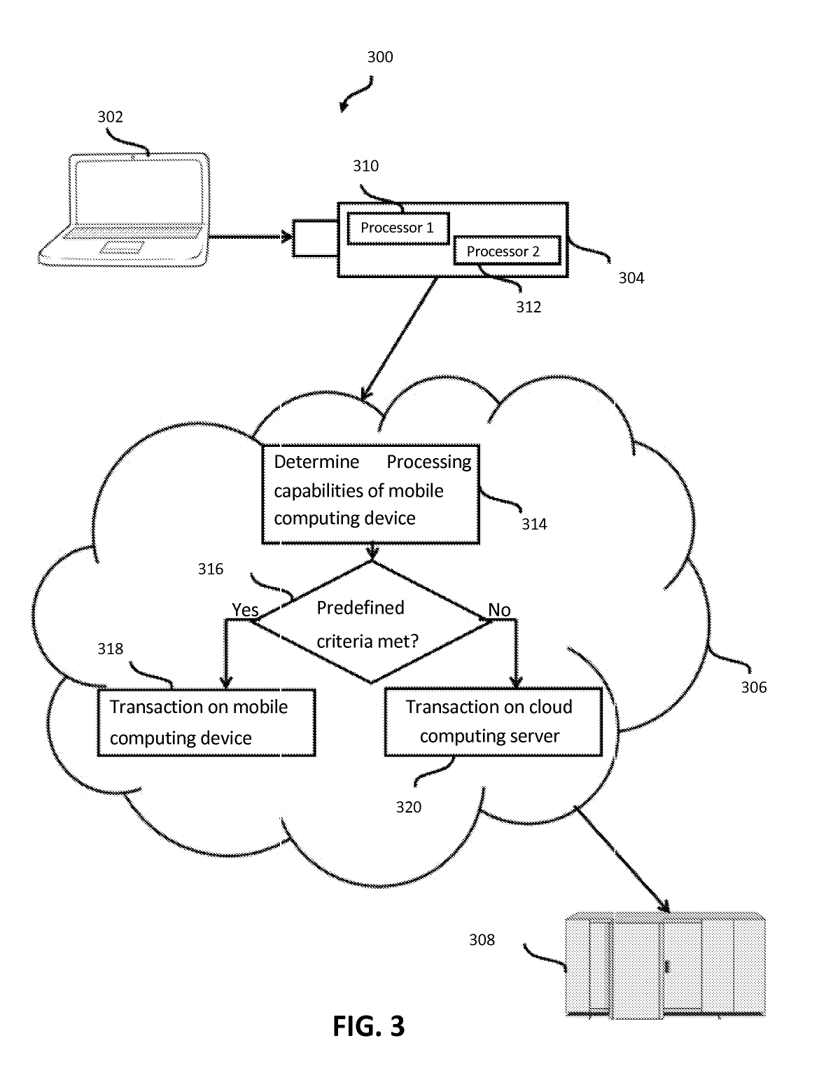

FIG. 3 illustrates the online trading system, as described and claimed in the present invention. The online trading system comprises a mobile computing device 302, an online trading plug and play device 304, a cloud computing server 306, and a financial trading exchange 308. A user of the mobile computing device 302 is an online trading account holder having a paid subscription to access a financial trading exchange 308. The online trading plug and play device 304 is configured to connect with the financial trading server 308 over internet and perform financial transactions. The online trading plug and play device 304 comprises two processors. Processor 1, 310 is configured to request information processing onto the financial exchange. Processor 2, 312 is configured to interrupt the information processing request and determine the processing capabilities of the mobile computing device 302, and send the determined capabilities to the cloud computing server 306. The cloud computing server then processes the request using its own processing capabilities.

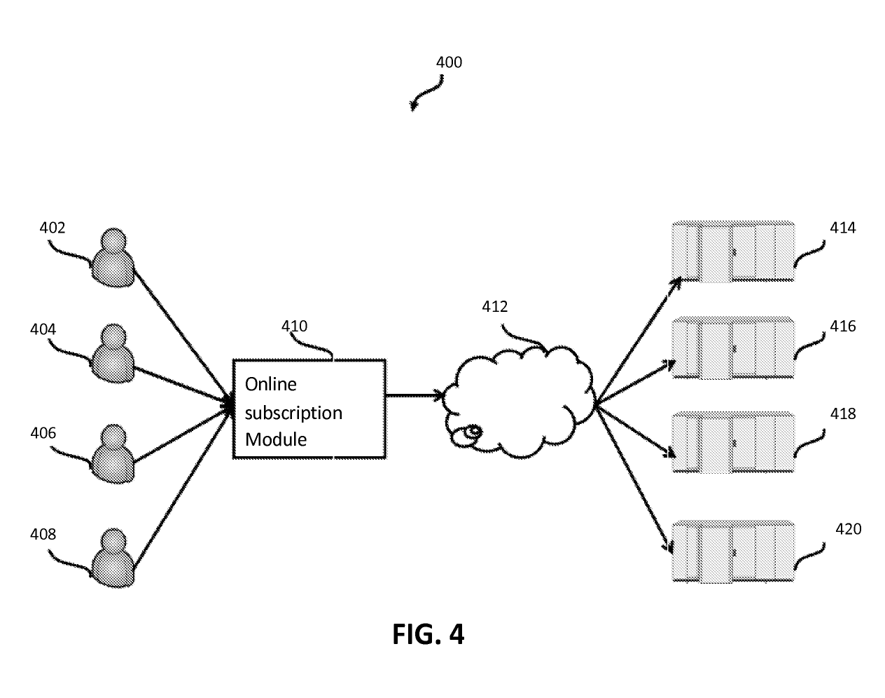

FIG. 4 illustrates the online trading network, as described and claimed in the present invention. The illustrated online trading network has multiple user nodes 402, 404, 406, and 408, multiple broker nodes, and multiple trade exchange nodes 414, 416, 418, and 420. These multiple user 402, 404, 406, and 408 are online trading account holders having a paid subscription to access a financial trading exchange. The multiple users 402, 404, 406, and 408, brokers, and trade exchange nodes 414, 416, 418, and 420 communicate over internet and uses a cloud computing server 412 perform financial transactions. The cloud computing server 412 has instructions stored to perform various functions.

The cloud computing server 412 authenticate multiple user nodes 402, 404, 406, and 408, multiple broker nodes and multiple trading exchange nodes 414, 416, 418, and 420 before granting access to the cloud computing server. The cloud computing server 106 is configured to provide its subscription based access to users to enable sale and purchase of financial instruments over internet. The cloud computing server 412 is also configured to be platform independent and thus using any third party application, the cloud computing server 412 can be upgraded to function on various computing platforms. To entertain the user's request, the online subscription 410 may, based upon the credits in the user's account, schedule an automatic up gradation task using the application platform. The cloud computing server 412 is also configured to store data packets exchanged between multiple users nodes 402, 404, 406, and 408, multiple broker nodes, and multiple exchange nodes 414, 416, 418, and 420. The cloud computing server 412 is also configured to enable automatic functioning of multiple user nodes 402, 404, 406, and 408, multiple broker nodes and multiple trading exchange nodes 414, 416, 418, and 420. The cloud computing server 412 is configured to utilize computing powers of multiple user nodes 402, 404, 406, and 408, multiple broker nodes and multiple trading exchange nodes 414, 416, 418, and 420 while rendering its services to them. The cloud computing server 412 pushes geographical dependent graphical user node interface onto the user and broker nodes. It should also be noted herein that, within the scope of this invention that the trading process as disclosed herein, can also be used for virtual trading with fake money where data may be live or delayed and derived from the exchange, or simulated from some other source, or artificially generated, but trading maybe happening not on the real exchange, but on an artificial exchange simulator kind of engine based upon buys and sell orders (virtual trading games/competitions etc.).

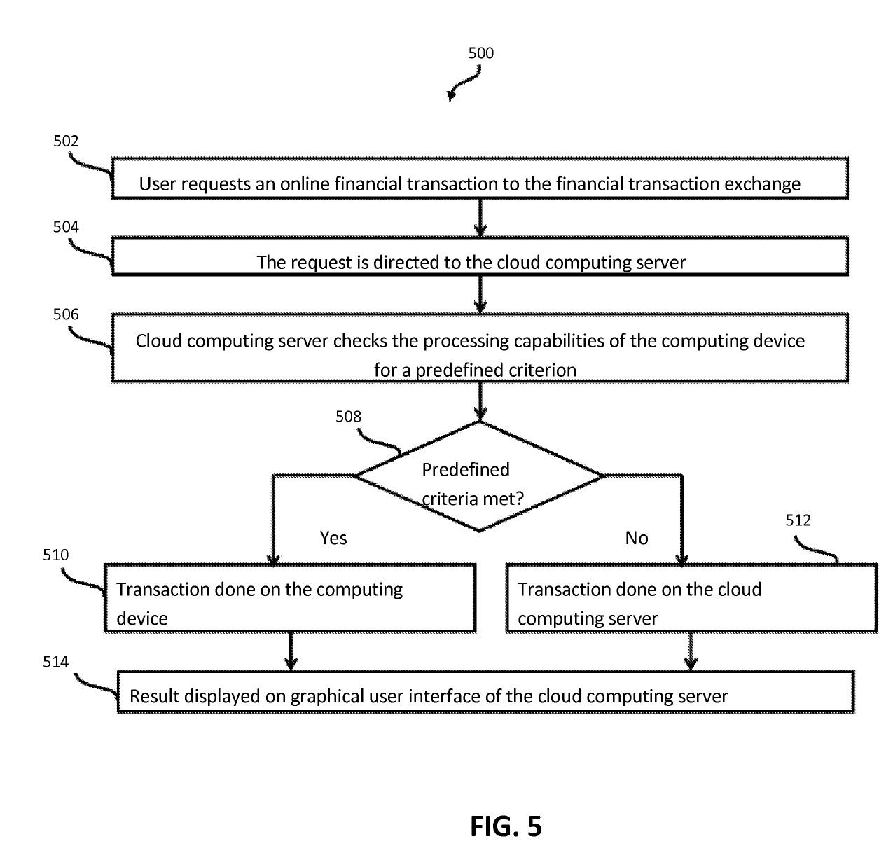

FIG. 5 is a flowchart showing a communication method, in accordance with an exemplary embodiment of the present invention. At operation 502, user of the computing device having a paid subscription access to a financial trading exchange requests for a financial transaction. At operation 504, the financial trading exchange directs the request to the cloud computing server. At operation 506, the cloud computing server checks the processing capabilities of the computing device. If at operation 508, the processing capabilities of the computing device successfully meet a certain predefined criteria, then the request for the financial transaction is executed using the computing device's hardware, at operation 510. Else, at operation 512, the request for the financial transaction is executed on the cloud computing server. At operation 514, the cloud computing server pushes the result onto the graphical user interface of the computing device.

Although the subject matter has been described in considerable detail with reference to certain preferred embodiments thereof, other embodiments are also possible. As such, the spirit and scope of the appended claims should not be limited to the description of the preferred embodiment contained therein. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, variations, improvements and/or substantial equivalents.

I claim:

1. An online computing system, the system comprising;
a first computing device controlled by a first user;
a second computing device controlled by second user;
a cloud computing resource comprising one or more of:
instructions to authenticate first and second computing device, instructions enable communication between first device and second device, instructions to implement third party applications on first and second device, instructions to store information received and conveyed to first and second computing device in distinct data packages, instructions to provide subscription based access of the cloud computing resource to the first and second user, instructions for automatic functioning of first and second device in absence of first and second user, instructions to utilize computing powers of the first and second device while rendering services to first and second device from a remote resource, instructions to push onto the first and second computing device plurality of geographical dependent graphical user interface and instructions enable sale and purchase of financial instruments over internet by first device and second device;
wherein the first computing device and the second computing device are configured to connect with a financial trading unit over the internet;
wherein the first user and second user implements on the cloud computing resource instructions to connect with the financial trading unit.

2. The system of claim 1, wherein the first user has an associated first computing device.

3. The system of claim 1, wherein the second user has an associated second computing device.

4. The system of claim 1, wherein the cloud computing resource is further capable of implementing instructions originating from the second user onto the first user.

5. The system of claim', wherein the first user, the second user and the cloud computing resource are connected to each other over one or more of: ethernet, local area network, virtual local area network, wide area network, internet, mobile network or a proprietary network.

6. The system of claim 1, wherein the first user and the second user are connected to one or more financial trading units.

7. An online trading system implemented over the internet, the system comprising:
a mobile computing device;
a financial trading exchange;
a cloud computing server;
wherein upon request from the mobile computing device to perform a financial transaction with the financial trading exchange, the cloud computing server performs a capability check to determine the processing parameters of the mobile computing device and perform one or more of:
perform the financial transaction using the processing capabilities of the mobile computing device, and perform the financial transactions utilizing the cloud computing server.

8. The system of claim 7, wherein the capability check is done to analyze mobile computing device's processor and hardware details, connectivity power network signal strength, battery life.

9. An online trading system having plurality of users and associated plurality of computing devices, each of the plurality of user connected with at least one of the plurality of financial exchanges such that each of the request for performing an online transaction from the user to the financial exchange is directed to at least one of the plurality of remote computing servers, the system comprising:
for each of the request, the remote computing server determines the requesting computing device's processor and hardware details, connectivity power network signal strength and battery life and performs one or more of:
execute the request for performing the financial transaction using the computing device's hardware, and execute the request for performing financial on the remote computing server and push the results of the request onto the computing device associated with the requesting user.

10. An online trading application plug and play device configured to connect and perform financial transactions with a financial exchange over internet, the device comprising:
a first processor configured to request information processing onto the financial exchange;
a second processor to interrupt the request and determine the processing capabilities of the computing device into which the plug and play device is plugged in and to send the determined capabilities to a remote server having a subscription based access, the remote server, subject to determined capabilities, configured to process the request using the processing capabilities of the computing device.

11. The device of claim 10, wherein, subject to the determined capabilities, the remote server configured to process the request using the processing capabilities of the remote server and push the outcome of the processing onto the display of the computing device.

12. The device of claim 10, wherein the remote server is configured to implement one or more of:
instructions to authenticate the computing device before granting access to the remote cloud resource, instructions to implement third party computer readable applications on the computing device, instructions to store information received and conveyed computing device in distinct data packages, instructions for automatic functioning of the plug and play device when plugged into the computing device, instructions to automatically utilize computing powers of the computing device while rendering services to the plurality computing device from the financial exchange, instructions to push onto display associated with the computing device geographical dependent graphical user node interface and instructions to enable sale and purchase of financial instruments over internet by the computing device.

13. An online trading network, the network comprising:
plurality of user nodes;
plurality of broker nodes;
plurality of trading exchange nodes;
wherein at least one of the plurality of user nodes is connected to at least one of the plurality of broker nodes and at least one of the plurality of trading exchange nodes such that communication and financial transactions between the plurality of user nodes, the plurality of broker nodes and the plurality of trading exchange nodes happens over an internet due instructions stored in a remote cloud resource, the remote resource comprising one or more of:
instructions to authenticate the plurality of user nodes, the plurality of broker nodes and the plurality of trading exchange nodes before granting access to the remote cloud resource, instructions to implement third party computer readable applications on the plurality of user nodes, the plurality of broker nodes and the plurality of trading exchange nodes, instructions to store information received and conveyed to the plurality of user nodes, the plurality of broker nodes and the plurality of trading exchange nodes in distinct data packages, instructions to provide subscription based access of the cloud computing resource to the plurality of user nodes, the plurality of broker nodes and the plurality of trading exchange nodes, instructions for automatic functioning of the plurality of user nodes, the plurality of broker nodes and the plurality of trading exchange nodes, instructions to utilize computing powers of the plurality of user nodes, the plurality of broker nodes and the plurality of trading exchange nodes while rendering services to the plurality of user nodes, the plurality of broker nodes and the plurality of trading exchange nodes from another resource, instructions to push onto the plurality of user nodes and the plurality of broker nodes plurality of geographical
dependent graphical user node interface and instructions enable sale and purchase of financial instruments over internet by the plurality of user nodes.

14. A trading system, the system comprising:
an online trading account holder having a paid subscription to access a financial asset such that a request for performing plurality of transactions over the financial asset by the account holder is processed by a remote server using the processing capabilities of the computing device associated with the online trading account holder such that in an event that the processing capabilities meet a predetermined criterion, the processing is done using the processing capabilities of the computing device else using the processing capabilities of the remote server.

15. The system of claim 14, wherein the financial assets is one or more of: an information source, a stock exchange, bonds, derivatives and currencies.

16. The system of claim 14, wherein the system is an internet based website.

17. The system of claim 14, wherein the system is a plug and play device.

18. The system of claim 14, wherein the system is a chip.

19. The system of the claim 14, wherein the computing device is a computer.

20. The system of the claim 14, wherein the computing device is a handheld device.

21. The system of the claim 14, wherein the remote server implement one or more of:
instructions to authenticate the computing device before granting access to the remote server, instructions to implement third party computer readable applications on the computing device, instructions to store information received and conveyed computing device in distinct data packages, instructions for automatic functioning, instructions to automatically utilize computing powers of the computing device while rendering services to the plurality computing device from the stock exchange, instructions to push onto display associated with the computing device geographical dependent graphical user node interface and instructions to enable sale and purchase of financial instruments over internet by the computing device.

22. A method to query a stock exchange, the method comprising:
receiving a query from a device;
connecting with a stock exchange to seek response for the query;
determining processing capabilities of the device;
inputting access parameters onto an online webpage to gain access to a remote server;
sending the determined processing capabilities of the device to the remote server;
processing the query using one or more of: computing capabilities of the device and computing capabilities of the remote server.
